(19) United States
(12) Patent Application Publication
(10) Pub. No.: US 2010/0202648 A1
(43) Pub. Date: Aug. 12, 2010

(54) COVER FOR APERTURES OF AN ELECTRIC MICRO-DEVICE HOUSING

(75) Inventors: Erich Dittli, Reichenburg (CH); Jan Angst, Hirzel (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 12/664,783

(22) PCT Filed: Jun. 18, 2007
(86) PCT No.: PCT/EP07/56035

§ 371 Date: Apr. 22, 2010

(51) Int. Cl. H04R 19/00

(52) U.S. Cl. 381/361

(57) ABSTRACT

At an electronic micro-device (1) as in particular at hearing aids and the like means are proposed for the at least partial covering or sealing of housing openings (3,5). The opening (3,5) is covered by a film or membrane (9) which is at least partially acoustically transparent at audible frequencies, which is hydrophobic and dirt repellent and which is held on the opening by means of a housing cover or a cap (11), surrounding the opening.

This invention relates to means for covering apertures of a housing for electric micro-devices as specified in the preamble of claim 1, a process for at least partially closing of apertures to a housing for electronic micro-devices as well as the use of the means at hearing aids. The sealing of openings in electronic micro-devices as in particular for microphones, loudspeakers and the like, e.g. at hearing aids, represents a relatively frequent problem. In particular, preventing the contamination or clogging within the apertures and in addition to prevent the penetration of humidity are still an existing problem. On one side, acoustic transparency should be guaranteed and on the other side e.g. the penetration of humidity can cause a complete failure of a microphone.

Known is e.g. the use of porous sintered polymer materials, as e.g. known under the trade name “Porex” (Porex Corporation). This material usually is relatively porous and crumbly, which for the user as well for a technician, such as an acoustician is difficult to handle, e.g. when it has to be exchanged due to high contamination.

Within the DE 10 2005 012 149 B3, a protective film is arranged within a carrier housing and the assembly is placed over the apertures. On one side, this solution is relatively expensive and furthermore, there exists the danger that gaps between the carrier of the assembly and the hearing aid housing are not tight.

A further solution is known from so-called mobile phones, where a film is either placed inside the housing over a microphone or a loudspeaker or is placed from inside over the housing opening by means of a clamping ring. Again to replace those membranes due to high contamination is extremely problematic.

In the EP 0 847 227, again as mentioned above, the use of an open porous material is proposed. In the EP 0 310 866, the use of a microphone membrane is proposed, consisting of a non-adhering material.

EP 1 324 634 proposes a cover with the use of a fixing grid, in which embedded a small porous non-woven is arranged. In this case, the problem exists in a reduced acoustic transparency and furthermore there exists the danger of uptight gaps between the cover and the housing.

In a similar way the EP 1 439 733 proposes the use of a microphone protection, which by means of a ring, comprising fixing bars, is held in position.

The object of the present invention consists therefore in providing protective means to cover the apertures at electronic or electric micro-devices which are easily exchangeable, easy to clean and which are acoustically transparent at audible frequencies.

According to the invention, this objective is achieved by means as described in claim 1. As a proposed solution, means are provided for the at least partial covering or sealing, respectively, of housing openings or apertures respectively at electronic micro-devices, as in particular hearing aids and the like, comprising primarily a film or membrane, which covers the opening, which is at least partially permeable to oxygen, which is hydrophobic and which is held in position on the opening by means of a housing cover or a cap, which surrounds the opening.

The film or membrane can be a hydrophobic fabric, a non-woven, a very slim film membrane or the like, which is preferably deformable.

The opening or aperture of the electronic micro-device housing according to one solution of the invention is enclosed by a ridge along the outer edge of the opening, over said ridge or over said edge, respectively, the film or membrane is stretched to cover the opening. The film or membrane is kept in position by means of the housing cover or the cap, clamping the film or membrane on the edge.

According to a further solution, the cap or the cover can be shaped double-walled and the film or membrane is arranged between the walls by clamping. In other words, the tap or cover is consisting of two-layered walls between which layers the film or membrane is integrally arranged. As a consequence, the film does not have to be arranged on the openings of the electronic device housing but shall be arranged together with the cap or cover to be placed on the housing of the device.

Again, according to a further solution, the ridge or the edge, respectively, of the opening is designed within an inclined decreasing outer shape in outward direction seen from the opening and the edge of the respective opening within the cover or the cap is designed in accordance, such that the interior shape of the opening edge at the cover, as well as the inclined decreasing shape of the edge of the housing opening are abutting in a plane to each other to guarantee in between a preferably plain clamping of the film or the membrane.

Furthermore, it is proposed that the ridge or edge of the housing opening, as well as the inner opening edge of the cover are dimensioned and designed such in accordance to each other that, when mounted, the film or membrane is almost within the plane of the outer surface of the cover or cap. This allows the cleaning of such a device by the end-user.

Further possible solutions of the inventive means are characterized within dependent claims.

In addition, a process is proposed for at least partially closing or sealing a housing opening of an electric or electronic micro-device in accordance with the wording of claim 8.

The invention shall be described in more detail with reference to the attached figures, in which:

FIG. 1 shows schematically in perspective view arranging a film on openings of a hearing aid housing by use of a housing cover or cap,

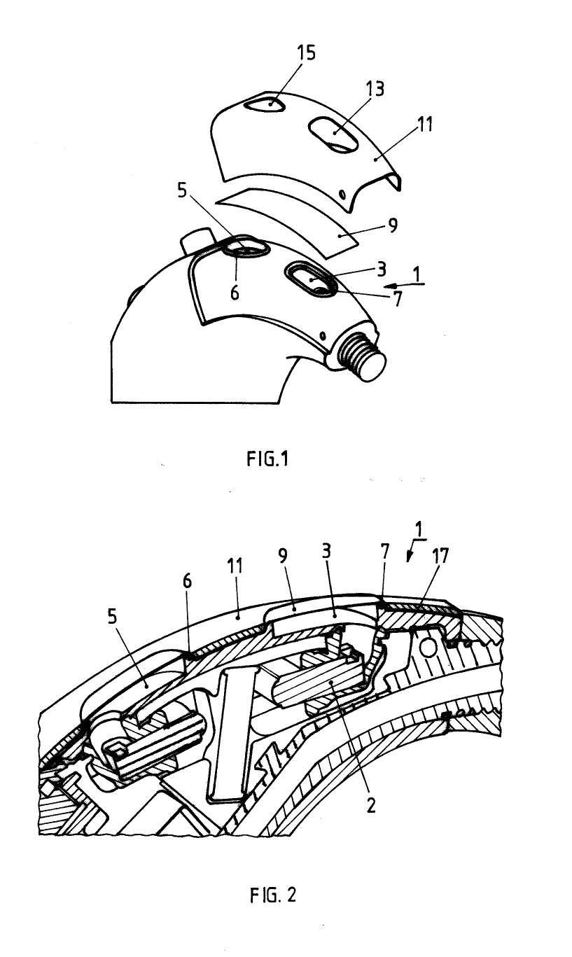

FIG. 2 in perspective sectional view the covering or sealing of openings within a hearing aid housing and

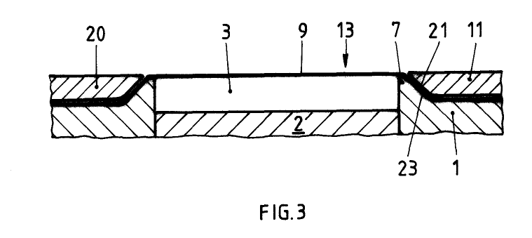

FIG. 3 in sectional view an extract of the embodiment as shown in FIG. 2.

A hearing aid housing 1 comprises openings 3 and 5, e.g. for acoustic transparency within the housing for a microphone or a loudspeaker or the like. The two openings 3 and 5 are surrounded or enclosed by outer edges 6 and 7, on which the film or membrane 9 can be placed. This film or membrane 9 is preferably very thin and elastic, so that a certain permeability to air is guaranteed. It can also be a non-woven, a fabric or the like. Furthermore the film or membrane 9 is hydrophobic, to prevent the penetration of humidity.

Finally the film or membrane 9 is kept in position on the two openings 3 and 5 by means of a housing cover 11, in which openings 13 and 15 are provided in accordance to the openings 3 and 5 within the hearing aid housing 1.

Within the outer housing wall surface of the hearing aid housing 1 a stepped recessed area 17 is provided, which is shaped accurate to the dimensions of the cover 11, to be arranged on the outer hearing aid housing surface without the creation of any steps.

FIG. 2 shows in sectional view the area of the two openings 3 and 5 whereas the circuits or elements 2 respectively which are arranged on the interior side of the openings should not be described any further. Usually such kind of openings 3 and 5 are provided for microphones, loudspeaker, a battery compartment or the like, so that e.g. acoustic transparency and/or permeability to air could be an important factor. The two openings 3 and 5 are enclosed by outer edges or ridges 6 and 7 as mentioned above and finally the two openings 3 and 5 are covered by the membrane 9. This membrane or film 9 is clamped in position on the two openings by means of the cover 11.

The cover 11 is arranged within the stepped recess portion 17 of the housing wall of the hearing aid 1.

FIG. 3 shows in an enlarged extract view of FIG. 2 the opening 3 in sectional view, where it can be recognized that the edge 7 of the opening has a slanting outer bevel 21. Correspondingly, the interior edge 23 of the opening 13 within the cover 11 is slanted in accordance with the outer bevel 21 of edge 7, and as a result, the film or the membrane 9 respectively is uniformly clamped between outer bevel 21 and interior edge 23. A further advantage is that the mounted membrane is more or less flush with the outer surface 20 of the housing cover 11. Therefore, on one side the danger of contamination can be reduced and on the other side a simple cleaning of the membrane 9 can be achieved.

In case of continued use the film or membrane 9 must be replaced, which can be done in a simple manner by only removing the housing cover 11 and by replacing the film or membrane 9. This in contrast to all various solutions as known in the art, where neither a simple cleaning of only moderate contamination is possible nor the replacement of a singular film or membrane can be done at all.

The proposed solution with reference to the FIGS. 1 to 3 does only represent one example, which can be changed or amended in any possible manner. In particular, a different design of the edge or the cover can be chosen as well as the way of fixing the membrane or foil on the opening by means of the cover or cap. In addition at this place no further information should be given in relation to the used material for the film or membrane, as hydrophobic, air-permeable materials such as non-wovens, fabrics, thin films and the like are well known within the art.

What is claimed is:

1. An electronic micro device having means for an at least partial covering or sealing of a housing opening wherein the opening is covered by a film or membrane which is at least partially acoustically transparent at audible frequencies, and which is held on the opening by means of a housing cover or a cap, surrounding the opening.

2. The device according to claim 1, wherein the film or membrane is hydrophobic and dirt repellent.

3. The device according claim 1, wherein the film or membrane is a hydrophobic fabric, a non-woven or the like which preferably is deformable.

4. The device according to claim 1, wherein the opening is enclosed by an edge-like formed ridge over which the film or membrane is stretched covering the opening, whereas the film or membrane is clamped on the edge by means of the cover or cap.

5. The device according to claim 1, wherein the cap or the cover is shaped double-walled, and the film or membrane is arranged between the two walls by clamping.

6. The device according to claim 1, wherein the ridge of the edge of the opening comprises a slanted outer bevel and that the respective opening within the housing cover or the cap comprises a correspondingly slanted interior edge, so that the two slanted surfaces abut to each other to ensure a uniform clamping of the film or foil between the two surfaces.

7. The device according to claim 1, wherein the interior edge of the opening of the housing cover or the cap is designed and dimensioned in such a way that the mounted film or membrane is approximately flush with the outer surface of the housing cover or the cap.

8. The device according to claim 1, wherein the housing wall of the micro-device comprises a stepped recessed area designed in accordance with the housing cover or the cap such so that an at least almost step-less arranging of the cap or cover on the device housing wall of the electric device is possible.

9. Process for the at least partial covering of a housing opening of an electric or electronic micro device housing as in particular of a hearing aid housing and the like, characterized in that the opening will be covered by means of a film or membrane, which is at least partially acoustically transparent at audible frequencies and hydrophobic and dirt repellent and that afterwards the film or membrane is clamped on the opening by means of a housing cover or a cap surrounding the opening of the housing.

10. Use of the device according to claim 1, for the covering or sealing housing openings within a hearing aid housing.
